(19) United States
(12) Patent Application Publication
(10) Pub. No.: US 2016/0345600 A1
(43) Pub. Date: Dec. 1, 2016

(54) BEVERAGE CONCENTRATE WITH TEA FLAVOUR

(71) Applicant: GIVAUDAN S.A., Vernier (CH)

(72) Inventors: Vivianne MONNIER, Schwerzenbach (CH); Lai Yi CHAN, Zurich (CH)

(21) Appl. No.: 15/114,019

(22) PCT Filed: Feb. 16, 2015
(86) PCT No.: PCT/EP2015/000334

§ 371 Date: Jul. 25, 2016

(30) Foreign Application Priority Data
Feb. 17, 2014 (GB) 1402745.2

(51) Int. Cl. A23F 3/16; A23F 3/42

(52) U.S. Cl. CPC A23F 3/163; A23F 3/426

(57) ABSTRACT

A tea-flavoured beverage concentrate, comprising a beverage concentrate base in which tea flavour is provided by the incorporation of tea distillate. Dilution of this composition results in a tea-flavoured beverage that suffers from less of the cloudiness, precipitation or sedimentation that has previously been encountered in preparing tea-flavoured concentrates.

This disclosure relates to beverages, to concentrates for making beverages and to a method of preparation of such concentrates.

An increasingly popular way of providing beverages is in concentrated form. This form has the advantages of considerably reducing the storage space required and of permitting a manufacturer or consumer to select his or her own preferred concentration by adding the concentrate to a desired volume of water.

There are several different forms of concentrate. One common form is a beverage emulsion, essentially a concentrated aqueous emulsion of the desired flavour plus some (but not all) of the other desired ingredients, such as colour. The beverage is prepared by adding the desired proportion of water, plus other ingredients such as acids and sweeteners. A more recent type is the liquid water enhancer (LWE). This contains all of the ingredients of a beverage, and only water need be added.

Because of the nature of the concentrates (high concentrations of acids resulting in low pH values, solvents, high content of substances to be dissolved such as artificial sweeteners), not all desired beverage ingredients are suitable for use in concentrates. One of these is tea. A desirable concentration of tea extracts will precipitate under such conditions, so that there will be an unsightly layer of precipitate in the bottom of the concentrate container, and the final beverage will be undesirably cloudy. As a result, any “tea” concentrates use tea flavours, as opposed to plant-derived tea material. This is especially true for LWEs, in which the environment is particularly harsh, but it applies to all concentrates to some extent. Given the desire for authentic, natural materials, there is an unfilled gap in the market.

It has now been found that it is possible to make an authentic plant-derived tea-flavoured beverage concentrate. There is therefore provided a tea-flavoured beverage concentrate, comprising a beverage concentrate base in which tea flavour is provided by the incorporation of tea distillate.

By “beverage concentrate base” is meant all of the usual art-recognised ingredients found in beverage concentrates. These include flavours, solvents, acids, colouring matters, thickening agents, suspending agents and artificial sweeteners. The flavours may include any suitable and desirable flavours in which a tea flavour is desired, for example, citrus flavours, such as orange, lemon, lime and grapefruit.

By “tea distillate” is meant a product obtained by the distillation of tea. This is typically done by steam distillation, e.g. using a simple batch tank or a continuous process such as a spinning cone column. Such a product is typically a clear aqueous solution of volatiles (top notes). Such distillates are commercially available and they are typically used to produce normal-strength tea-flavoured beverages. It has not been previously recognised that, not only can they be used in beverage concentrates, but also that they bring considerable advantages in being able to withstand the harsh conditions of this environment.

A tea distillate is incorporated into a beverage concentrate base by first blending all ingredients of the concentrate, other than the tea distillate, and then combining the mixture with the tea distillate. The proportion of tea distillate used can vary over a wide range, depending on the nature of the flavour desired, but the tea distillate will be present at a rate of from 5-50% of the concentrate. Other typical concentrations are from 10-25%, particularly from 19-21%.

The use of a tea distillate in a beverage concentrate surprisingly results in a tea-flavoured beverage that suffers from less of the cloudiness, precipitation or sedimentation that has previously been encountered in preparing tea-flavoured beverage concentrates.

There is therefore also provided a tea-flavoured beverage, comprising a diluted beverage concentrate composition as hereinabove described.

In a particular embodiment, the concentrate is an LWE. As previously mentioned, the challenges facing natural tea flavour are especially severe in LWEs, and it is a particular benefit that the present disclosure makes a natural tea-flavoured LWE possible.

The disclosure is further described with reference to the following non-limiting examples.

### COMPARATIVE EXAMPLES C1-C2, EXAMPLES 1-2: LIQUID WATER ENHANCERS

A beverage concentrate base was prepared by blending the following ingredients (parts by weight):

| | |
|---|---|
| Water | 569.12 |
| Sucralose | 17.05 |
| Allura Red* | 0.51 |
| Sunset Yellow* | 3.07 |
| Brilliant Blue* | 0.14 |
| Tartrazin* | 1.02 |
| Citric acid | 34.09 |
| Malic acid | 306.82 |
| Sodium citrate | 68.18 |

*Food dye

Beverage concentrate samples were prepared by blending the beverage concentrate base described above with tea ingredients in amounts indicated in the following table

| | | concentrate | Tea ingredient | |
|---|---|---|---|---|
| | | base (parts | (parts by | |
| Example | Tea ingredient used | by weight) | weight) | Observations |
| C1 | Instant tea (Templar | 90 | 10 | Ingredient |
| | Food Products, New | | | insoluble; strong |
| | Providence NJ, USA) | | | sediment |
| C2 | Black tea extract | 90 | 10 | Ingredient |
| | (Plantextrakt GmbH, | | | insoluble; strong |
| | Vestenbergsgreuth, | | | sediment |
| | Germany) | | | |
| 1 | Black tea distillate | 80 | 20 | Ingredient soluble; |
| | (Essence TE-101, | | | clear liquid |
| | Sensus, Hamilton OH, | | | |
| | USA) | | | |
| 2 | Green tea distillate | 80 | 20 | Ingredient soluble; |
| | (Essence GTE-502, | | | clear liquid |
| | Sensus, Hamilton OH, | | | |
| | USA) | | | |

Comparative concentrate examples C1 and C2 prepared with extracts had strong sediments, since the extracts were not fully soluble even when smaller amounts were added than in Examples 1 and 2.

Examples 1 and 2 remained clear without the formation of sediment for at least 6 months at ambient temperature.

### EXAMPLES 3-4: TEA FLAVOURED BEVERAGES

### Example 3: Black Tea Flavoured Beverage

1 g of the beverage concentrate of Example 1 was added to 100 ml of mineral water. This gave a beverage with the aroma and taste of a black tea beverage.

### Example 4: Green Tea Flavoured Beverage

1 g of the beverage concentrate of Example 2 was added to 100 ml of mineral water. This gave a beverage with the aroma and taste of a green tea beverage.

1. A tea-flavoured beverage concentrate, comprising a beverage concentrate base in which tea flavour is provided by the incorporation of tea distillate.

2. A tea-flavoured beverage, comprising a diluted beverage concentrate composition according to claim 1.

3. A tea-flavoured beverage according to claim 1, in which the concentrate base is a liquid water enhancer.
